(19) United States
(12) Patent Application Publication
(10) Pub. No.: US 2017/0234435 A1
(43) Pub. Date: Aug. 17, 2017

(54) WASTE GATE VALVE ACTUATOR

(71) Applicant: GM GLOBAL TECHNOLOGY OPERATIONS LLC, Detroit, MI (US)

(72) Inventors: Ingo HERMANN, Mainz (DE); Gerwin TITTES, Trebur (DE); Stephan FOELLER, Schluchtern (DE)

(73) Assignee: GM GLOBAL TECHNOLOGY OPERATIONS LLC, Detroit, MI (US)

(21) Appl. No.: 15/041,062

(22) Filed: Feb. 11, 2016

(30) Foreign Application Priority Data
Feb. 11, 2016 (DE) 102015001763.2

(51) Int. Cl. F16K 1/20; F02B 37/18

(52) U.S. Cl. CPC F16K 1/2014; F02B 37/186

(57) ABSTRACT

A waste gate valve actuator, that may be used for an exhaust gas turbocharger of a motor vehicle, may have a flap with a base surface to be supported on an edge of an inlet or outlet opening of a waste gate channel and a channel-side elevation, which at least in one cross section along its axial direction exhibits an outer contour with a first section and an adjoining section facing away from the base surface. The outer contour in the first section may have at least one outer tangent that includes a first angle deviating from zero with the axial direction, and in the second section may have at least two outer tangents spaced apart from each other in an axial direction that include the same second angle angle deviating from zero and the first angle with the axial direction, and/or wherein the elevation exhibits in particular a flat front surface facing away from the base surface, which in relation to the base surface-side floor surface of the elevation is offset toward a rotational axis of the flap.

### CROSS-REFERENCE TO RELATED APPLICATION

This application claims priority to German Patent Application No. 102015001763.2, filed Feb. 11, 2015, which is incorporated herein by reference in its entirety.

### TECHNICAL FIELD

The present disclosure pertains to a waste gate valve actuator, in particular an exhaust gas turbocharger of a motor vehicle, an exhaust gas turbocharger with such a waste gate valve actuator, and a motor vehicle with such a waste gate valve actuator.

### BACKGROUND

Known from DE 10 2012 217 920 A1 is a waste gate valve with a waste gate valve actuator exhibiting a flap. The flap exhibits a base surface and an elevation resembling a truncated cone.

The object of implementing the present invention is to provide an improved exhaust gas turbocharger, in particular for a motor vehicle.

This object is achieved with a waste gate valve actuator with the features in claim 1. Claims 10 and 14 protect an exhaust gas turbocharger with a waste gate valve actuator described herein, or a motor vehicle with an exhaust gas turbocharger described herein. Advantageous embodiments of the invention are the subject of the subclaims.

### SUMMARY

In accordance with an aspect of a herein described embodiment, a waste gate valve actuator for an exhaust gas turbocharger that may find application in a motor vehicle may have a flap with a base surface, which may be provided or set up to be tightly supported on an edge of an opening of a waste gate channel and/or a channel-side elevation. The waste gate channel or channel-side elevation in at least one cross section along an axial direction may have an outer contour with a first (axial j section and an adjoining (axial) section facing away from the base surface. The outer contour in the first section may have one or more outer tangents spaced apart from each other in an axial direction, which may include the same first angle deviating from zero with the axial direction, and in the second section have two or more outer tangents spaced apart in the axial direction. Which may include the same second angle deviating from zero and the first angle with the axial direction.

In an additional or alternative embodiment, a waste gate valve actuator for an exhaust gas turbocharger that may be used in a motor vehicle, may have a flap with a base surface, which may provided or set up to be tightly supported on an edge of an opening of a waste gate channel and/or a channel-side elevation. The channel in at least one cross section along an axial direction may have an outer contour with a first (axial) section and an adjoining (axial) section facing away from the base surface. The elevation may be a flat front surface facing away from the base surface that in relation to the base surface-side floor surface of the elevation passes over into the base surface or adjoins that latter, is offset toward a rotational axis of the flap perpendicular to the axial direction, around which the flap can be pivoted between a closed position, in which its base surface is supported on an edge of the opening, and at least one closed position, in which the base surface is spaced apart from the edge.

In one embodiment specifically contouring the elevation may make it possible to advantageously prescribe a free-flowing surface of the opening and/or flow volume through the opening, in particular at least regionally concave over the travel of the flap between a closed and (maximally) opened position.

In another embodiment at least two outer contour sections, which exhibit outer tangents at least in part differently inclined against the axial direction, wherein at least one contour section facing away or located remotely from the base surface may have at least two parallel outer tangents spaced apart from each other in the axial direction.

In addition, in a herein described embodiment an advantageous characteristic, in particular one that is at least essentially linear at least sectionally, can be created by an elevation with a front surface that faces away from the base surface, and is offset toward a rotational axis of the flap in relation to a floor surface of the elevation.

An embodiment of the exhaust gas turbocharger may have at least one turbine with at least one turbine wheel, which is arranged in an exhaust gas passage of an internal combustion engine or provided or set up for this purpose, and at least one compressor with at least one compressor wheel, which is coupled with the turbine wheel, in particular rigidly connected thereto, and arranged in an air supply passage of the internal combustion engine or provided or set up for this purpose. In an embodiment, the waste gate channel is fluidically connected in parallel with the turbine wheel, and connected with the exhaust gas passage on either side of the turbine via the opening and an additional opening lying opposite thereto, wherein the one opening can be optionally closed or enlarged, in particular continuously, or reduced, in particular down to zero, by adjusting the flap of the waste gate valve actuator. In an embodiment, the opening that can be closed or covered by the flap is an inlet opening of the waste gate channel upstream from the turbine, while in another embodiment it is an outlet opening of the waste gate channel downstream from the turbine.

In an embodiment, the axial direction may be a rotationally symmetrical axis of the elevation and/or base surface and/or floor surface. Accordingly, the elevation may be rotationally symmetrical relative to the axial direction. This makes it possible to improve the production and/or (flow) characteristics of the flap. Additionally or alternatively, the axial direction may include an angle with a perpendicular on the base surface and/or floor surface and/or (with the flap closed) with a perpendicular on the opening of the waste gate channel that measures at most 30°, in particular at most 5°, in particular at most 1°. Additionally or alternatively, the axial direction can include an angle with the rotational axis of the flap that measures at least 75°, in particular at least 80°, in particular about 90°.

In an embodiment that is not rotationally symmetrical relative to the axial direction, the elevation, in particular a center or centroid line of the elevation, is inclined against the axial direction, either sectionally or over its entire extension.

In an embodiment, the first section may extend over at least 20%, in particular at least 25%, in particular at least 30%, of an overall height of the elevation in an axial direction. Additionally or alternatively, it can adjoin the base surface or, in particular in a radius, pass over into the latter. This makes it possible to improve the production and/or (flow) characteristics of the flap.

In an embodiment, the second section may extend over at least 20%, in particular at least 25%, in particular at least 30%, of an overall height of the elevation in an axial direction. Additionally or alternatively, it can adjoin in particular a flat front surface of the elevation facing away from the base surface, or, in particular in a radius, pass over into the latter. A flat front surface of the elevation may be perpendicular to the axial direction and/or exhibit a front surface whose maximum and/or minimum dimensions measure at most 75% and/or at least 15% of the maximum and/or minimum dimensions of the base surface. This makes it possible to improve the production and/or (flow) characteristics of the flap.

In an embodiment, the outer contour in the first section and/or in the second section may be completely or partially straight. In a further development, the elevation correspondingly may have a first section with a truncated contour that is closer to the base surface, in particular adjoining the base surface, and a second section with a conical or truncated contour, in particular adjoining the first section and/or front surface of the elevation, wherein the second section exhibits a larger cone angle in a further development. This makes it possible to improve the production and/or (flow) characteristics of the flap. The outer contour in the first section and/or in the second section may be completely or partially curved. In a further development, the elevation may be a freeform contour with the first and second section, which may have outer tangents at least in part differently inclined against the axial direction, wherein, in a further development, at least one contour section facing away or located remotely from the base surface exhibits at least two parallel outer tangents spaced apart from each other in the axial direction. This makes it possible to improve the (flow) characteristics of the flap.

In an embodiment, the outer contour of the elevation between the base surface and floor surface and its front surface may be free of kinks with angles measuring more than 45°, in particular more than 30°, in particular more than 5°, and in a further development is free of kinks between the base surface and front surface. Furthermore, the outer contour may form an angle with the base surface and/or front surface exceeding 45°, and may have a kink whose angle measures more than 45°. This makes it possible to improve the production and/or (flow) characteristics of the flap.

In an embodiment, the base surface is flat. In another embodiment, an outer edge of the base surface is offset toward the elevation or away from the elevation in an axial direction relative to a transition in the elevation or relative to the floor surface. This makes it possible to improve the sealing characteristics of the flap and/or its installation space.

In an embodiment, the base surface and elevation are designed as a single piece with each other. This makes it possible to improve the production and/or stability of the flap.

In an embodiment, the flap is movably joined with a carrier. This makes it possible to advantageously improve a seal and/or offset tolerances. In another embodiment, the flap is rigidly joined with a carrier or designed as a single piece with the latter. This makes it possible to improve the stability of the flap.

In an embodiment, a turbocharger housing of the exhaust gas turbocharger may have the (inlet or outlet) opening of the waste gate channel and the waste gate valve actuator described herein, whose flap can be adjusted, for example pivoted and/or axially moved, between a closed position, in which its base surface is supported on an edge of the opening, and one or more open positions, in which the base surface is spaced in particular increasingly apart from the edge, in particular mounted so that it can be adjusted, for example pivoted and/or axially moved, via the carrier, in particular on the turbocharger housing.

In an embodiment, the opening and flap are designed in such a way that a free-flowing surface of the opening and/or flow volume through the opening increases to less of an extent over a travel of the flap between the closed and a maximally open position in a first travel range than in a second travel range subsequent thereto, in which the flap is spaced farther away from the opening, and for example, in such a way that the free-flowing surface and/or flow volume increases to more of an extent over the travel in a third travel range subsequent to the second travel range, in which the flap is spaced farther away from the opening, than in the second travel range. In other words, the correspondingly contoured elevation may be used in an embodiment to create an at least regionally concave progression of free-flowing surface or flow volume over the travel. This makes it possible to more sensitively adjust the free-flowing surface or flow volume in the first travel range.

In an embodiment, the opening and flap are designed in such a way that a free-flowing surface of the opening and/or flow volume through the opening increases at least essentially linearly over a travel, for example, over the travel of the flap between a closed and maximally open position in at least one travel range. In an embodiment, this makes it possible to advantageously adjust the free-flowing surface or flow volume.

### BRIEF DESCRIPTION OF THE DRAWINGS

The present invention will hereinafter be described in conjunction with the following drawing figures, wherein like numerals denote like elements.

FIG. 1 is a waste gate valve of an exhaust gas turbocharger with a waste gate valve actuator according to an embodiment of the present invention in a cross section along an axial direction;

FIG. 2 is a waste gate valve of an exhaust gas turbocharger with a waste gate valve actuator according to another embodiment of the present invention in a depiction corresponding to FIG. 1;

FIG. 3 is a free-flowing surface or flow volume of the waste gate valve on FIGS. 1, 2 over a travel of the waste gate valve actuator; and

FIG. 4 is a waste gate valve of an exhaust gas turbocharger with a waste gate valve actuator according to another embodiment of the present invention in a depiction corresponding to FIGS. 1, 2.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

FIG. 1 shows a waste gate valve of an exhaust gas turbocharger with a waste gas valve actuator according to an embodiment of the present invention in a cross section along an axial direction.

The waste gas valve actuator may have a flap with a base surface 1, which in a closed position depicted on FIG. 1 is supported tightly on an edge of an opening of a waste gate channel 2, and a channel-side elevation 3.

The base surface 1 and elevation 3 are rotationally symmetrical relative to an axial direction A denoted by a dash-dot line, which is perpendicular to the base surface 1 and, in the closed position, perpendicular to the opening of the waste gate channel 3.

The elevation 3 in the embodiment on FIG. 1 may have a first section adjoining the base surface 1 with a truncated contour and a second section with a truncated contour adjoining this first section and a front surface 3C of the elevation 3, wherein the second section exhibits a larger cone angle or is more obtuse.

Accordingly, an outer contour of the elevation 3 in the cross section on FIG. 1 may have a first section 3A along the axial direction A, and adjoining thereto a second section 3B facing away from the base surface, wherein the outer contour in the first section 3A may have outer tangents that coincide with the outer contour, which include a first angle a with the axial direction A of the latter that differs from zero, and in the second section may have outer tangents that coincide with the outer contour and are spaced apart from each other in the axial direction, which include a second angle β with the axial direction of the latter that differs from zero and the first angle α.

In the exemplary embodiment depicted in FIG. 1, the first section 3A extends over at least 20% of an overall height h of the elevation 3 in an axial direction A, and passes over in a radius (not depicted) into the base surface 1. In the exemplary embodiment, the second section 3B also extends over at least 20% of the overall height h, and passes over into the flat front surface 3C of the elevation 3 facing away from the base surface, whose diameter in the exemplary embodiment measures at most 75%, and at least 15%, of the diameter of the base surface 1.

In the exemplary embodiment on FIG. 1, the outer contour of the elevation 3 only exhibits a kink α→β between the base surface 1 and its front surface 3C, wherein its angle (α-β) measures no more than 45′.

In the exemplary embodiment on FIG. 1, the base surface 1 and elevation 3 are designed as a single piece with each other.

In the exemplary embodiment on FIG. 1, the flap is designed as a single piece with a carrier 4.

The flap can be pivoted between the closed position depicted on FIG. 1, in which its base surface 1 is supported on the edge of the opening of the waste gate channel 2, and a maximally open position, in which the base surface 1 is spaced maximally apart from the edge. To this end, the carrier 4 is pivoted to a turbocharger housing 5, as denoted on FIG. 1 by a tilt arrow s.

The opening and flap are designed in such a way that a free-flowing surface of the opening of the waste gate channel 2 and/or flow volume through the opening of the waste gate channel 2 increases to less of an extent over the travel s of the flap between the closed (s=0%) and maximally open position s=100%) in a first travel range s₁ than in a second travel range s₂ subsequent thereto, in which the flap is spaced farther away from the opening. To this end, FIG. 3 depicts a free-flowing surface or flow volume of the waste gas valve, which on FIG. 3 is marked Cd, over the travel s of the waste gate valve actuator. As evident, contouring the elevation 3 makes it possible to create a linear-concave progression for the free-flowing surface or flow volume over the travel s.

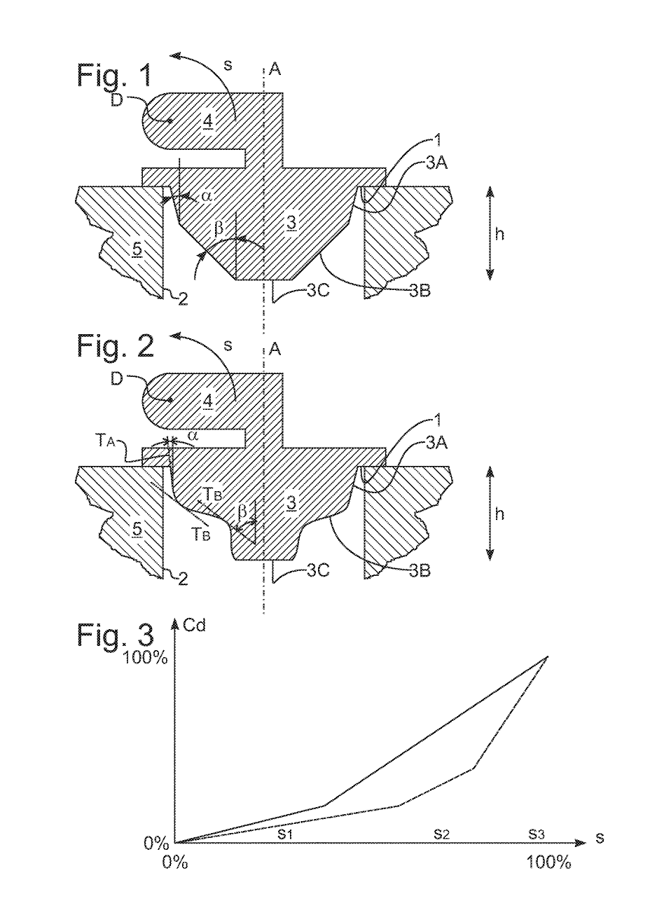

In a view corresponding to FIG. 1, FIG. 2 shows a waste gate valve of an exhaust gas turbocharger with a waste gate valve actuator according to another embodiment. Corresponding features are identified by identical reference numbers, so that reference will be made to the description above, and only differences will be covered below.

In the embodiment on FIG. 2, the elevation 3 rotationally symmetrical to the axial direction A exhibits a freeform contour. The outer contour is curved in a first section 3A and a second section 3B adjoining the latter, and exhibits no kinks between the base surface 1 and front surface 3C.

In the cross section on FIG. 2, the outer contour in the first section 3A may have at least one outer tangent T_{A} denoted with a double dot-dashed line, which includes a first angle a with the axial direction A that differs from zero, and in the second section 3 exhibits at least two outer tangents T_{B} denoted with a double dot-dashed line that are spaced apart from each other in an axial direction A (vertically on FIG. 2), which include a second angle β with the axial direction A of the latter that differs from zero and the first angle α.

To this end, a dashed line on FIG. 3 depicts the free-flowing surface or flow volume of the waste gate valve of FIG. 2 over the travel s of the waste gate valve actuator. As evident, contouring the elevation 3 makes it possible to create a linear-concave progression for the free-flowing surface or flow volume over the travel s. The free-flowing surface or flow volume over the travel s here increases to more of an extent in a third travel range s₃ subsequent to the second travel range s₂, in which the flap is spaced farther away from the opening, than in the second travel range s₂.

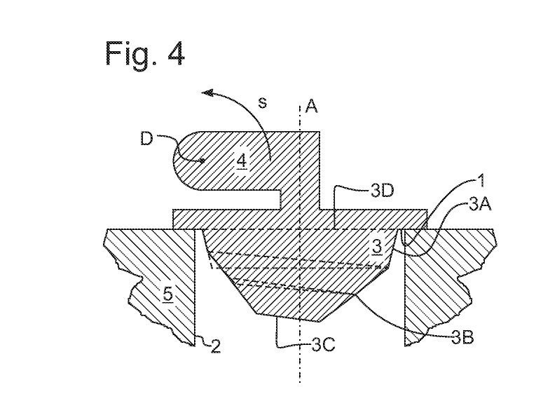

In a view corresponding to FIG. 1, FIG. 4 depicts a waste gate valve of an exhaust gas turbocharger with a waste gate valve actuator according to another embodiment. Corresponding features are identified by identical reference numbers, so that reference will be made to the description above, and only differences will be covered below.

In the embodiment on FIG. 4, the elevation 3 is not rotationally symmetrical relative to the axial direction A, but rather is generated in the exemplary embodiment by three consecutive truncated cones, whose axes are inclined relative to the rotational axis D of the flap, and which are denoted by dashed lines on FIG. 4 for illustrative purposes.

Accordingly, the elevation 3 here exhibits a flat front surface 3C that faces away from the base surface, and is offset toward the rotational axis D of the flap (to the left on FIG. 4) in relation to a base surface-side floor surface 3D of the elevation 3, in which the elevation 3 passes over into the base surface 1 or adjoins the latter, wherein the non-rotationally symmetrical elevation 3 is inclined against the axial direction A toward the rotational axis D of the flap in sections, namely in the area of the two truncated cones facing away from the base surface.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-14. (canceled).

15. A waste gate valve actuator, in particular for an exhaust gas turbocharger of a motor vehicle, which has a flap with a base surface to be supported on an edge of an inlet or outlet opening of a waste gate channel and a channel-side elevation, which at least in one cross section along an axial direction has an outer contour with a first section and an adjoining section facing away from the base surface, wherein the outer contour in the first section has at least one outer tangent that includes a first angle (α) deviating from zero with the axial direction, and in the second section has at least two outer tangents spaced apart from each other in the axial direction that includes a second angle (β) angle deviating from zero and the first angle (α) with the axial direction; wherein the elevation has a flat front surface facing away from the base surface, which in relation to a base surface-side floor surface of the elevation is offset toward a rotational axis of the flap.

16. The waste gate valve actuator according to claim 15, wherein the elevation is rotationally symmetrical relative to the axial direction.

17. The waste gate valve actuator according to claim 15, wherein the elevation is sectionally inclined against the axial direction.

18. The waste gate valve actuator according to claim 15, wherein the first section extends over at least 20% of an overall height of the elevation in an axial direction and optionally adjoins the base surface.

19. The waste gate valve actuator according to claim 15, wherein the second section extends over at least 20% of an overall height of the elevation in an axial direction and optionally adjoins a flat front surface of the elevation facing away from the base surface.

20. The waste gate valve actuator according to claim 15, wherein the outer contour in one of the first section and the second section is regionally straight or regionally curved.

21. The waste gate valve actuator according to claim 15, wherein the outer contour between the base surface and a front surface of the elevation is free of kinks with angles measuring more than 45°.

22. The waste gate valve actuator according to claim 15, wherein the base surface is one of flat or offset toward the elevation.

23. The waste gate valve actuator according to claim 15, wherein an outer edge of the base surface is one of offset toward the elevation and offset away from the elevation in an axial direction relative to a transition in the elevation.

24. The waste gate valve actuator according to claim 15, wherein the base surface and elevation are a single piece with each other.

25. The waste gate valve actuator according to claim 15, wherein the flap is movably or rigidly joined with a carrier (4) or designed as a single piece with the latter.

26. An exhaust gas turbocharger, in particular for a motor vehicle, with a turbocharger housing having an inlet or outlet opening of a waste gate channel and a waste gate valve actuator according to claim 15, whose flap can be adjusted to pivot between a closed position, in which its base surface is supported on an edge of the opening, and at least one open position, in which the base surface is spaced apart from the edge.

27. An exhaust gas turbocharger, in particular for a motor vehicle, with a turbocharger housing having an inlet or outlet opening of a waste gate channel and a waste gate valve actuator according to claim 15, whose flap can be adjusted to axially move between a closed position, in which its base surface is supported on an edge of the opening, and at least one open position, in which the base surface is spaced apart from the edge.

28. The exhaust gas turbocharger according to claim 26, wherein the opening and the flap provide free flow through the opening which increases to less of an extent over a travel of the flap between the closed and a maximally open position in a first travel range than in a second travel range, in which the flap is spaced farther away from the opening.

29. The exhaust gas turbocharger according to claim 27, wherein the opening and the flap provide free flow through the opening which increases to less of an extent over a travel of the flap between the closed and a maximally open position in a first travel range than in a second travel range, in which the flap is spaced farther away from the opening.

30. The exhaust gas turbocharger according to claim 28, wherein the opening and the flap provide free flow that increases to more of an extent over the travel in a third travel range subsequent to the second travel range, in which the flap is spaced farther away from the opening, than in the second travel range.

31. The exhaust gas turbocharger according to claim 29, wherein the opening and the flap provide free flow that increases to more of an extent over the travel in a third travel range subsequent to the second travel range, in which the flap is spaced farther away from the opening, than in the second travel range.

32. The exhaust gas turbocharger according to claim 30, wherein the opening and the flap provide free flow that increases linearly over a travel of the flap between the closed and a maximally open position in at least one travel range (s₁, s₂, s₃).

33. The exhaust gas turbocharger according to claim 31, wherein the opening and the flap provide free flow that increases linearly over a travel of the flap between the closed and a maximally open position in at least one travel range (s₁, s₂, s₃).

34. A motor vehicle, in particular passenger car, with an exhaust gas turbocharger according to claim 15.
